(19) United States
(12) Patent Application Publication
(10) Pub. No.: US 2010/0063746 A1
(43) Pub. Date: Mar. 11, 2010

(54) SYSTEM AND METHOD FOR DETERMINING A RISK RATING PROFILE OF SPECIFIC HORTICULTURAL ASSET PLANT SPECIES, INDIVIDUAL PLANTS AND A STAND OF PLANTS

(76) Inventors: Doug Cowles, Cary, NC (US); Sherri Koester, Cary, NC (US); Michael Dirr, Bogart, GA (US)

Correspondence Address: MAIER & MAIER, PLLC, 1000 DUKE STREET, ALEXANDRIA, VA, 22314, US

(21) Appl. No.: 12/555,100

(22) Filed: Sep. 8, 2009

Related U.S. Application Data
(60) Provisional application No. 61/136,471, filed on Sep. 8, 2008.

(51) Int. Cl. G06F 19/00

(52) U.S. Cl. 702/19

(57) ABSTRACT

In one embodiment, the invention may provide a system and method for determining the risk factor of individual and groups of plants by identifying a plant. Various characteristics about the plant or group of plants may then be collected and uploaded into a database. Local environmental characteristics may also be uploaded to determine the likelihood that certain adverse environmental factors may affect the plant. The uploaded characteristics of the plant and environmental factors may then be compared with predefined ratings associated with each characteristic and the ratings can be used to determine if the plant or group of plants might fail. Using this information, a risk factor for the property on which the plant or group of plants are located may be determined.

### PRIORITY

This application claims priority to provisional U.S. Patent Provisional Application No. 61/136,471, filed Sep. 8, 2008.

### BACKGROUND

Property is often valued, sold and insured based upon a variety of factors, ranging from location, to structures found thereon to potential uses for the property. One factor that may affect the value and insurability of a property is risks associated with the property. Risks may arise from any of a variety of sources, such as structural integrity, environmental elements or neighboring properties. Additionally, risks may arise from the trees and shrubs (hereinafter “plants”) or any other horticultural assets found on the property. Risks associated with plants are typically unknown to persons or entities who purchase, own or insure property, however.

### SUMMARY

In one embodiment a method of assessing a risk factor to property may be described. The method may include a step for identifying at least one plant proximate a piece of property; sizing the at least one plant; collecting data regarding condition and characteristics of the at least one plant; uploading the data to a database; comparing the data to predefined ratings associated with the at least one plant; applying the predefined ratings to the at least one plant to determine if the plant will fail; and determining a risk factor of the at least one plant to the property proximate the at least one plant.

In another exemplary embodiment, a system for assessing risk to property may be described. The system can include a processor, a memory associated with the processor, a piece of property having one or more plants located thereon, data regarding the one or more plants located on the piece of property and a database of predetermined characteristics of the one or more plants. The data regarding the one or more plants may then be inputted into the memory and may be compared to the predetermined characteristics of the one or more plants in the database to provide a risk assessment for the piece of property.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 is an exemplary flow chart showing a risk assessment system and method.

FIG. 2 is an exemplary table of risk assessment values.

FIG. 3 is an exemplary table of risk assessment values.

### DETAILED DESCRIPTION

This application relates to the subject matter of U.S. patent application Ser. No. 10/719,741 filed Nov. 21, 2003 and U.S. patent application Ser. No. 10/642,865 filed Aug. 18, 2003, the contents of which are hereby incorporated in their entirety.

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the term “embodiments of the invention,” “embodiments” or “invention” do not require that all embodiments of the invention include the discussed feature, advantage or more of operation.

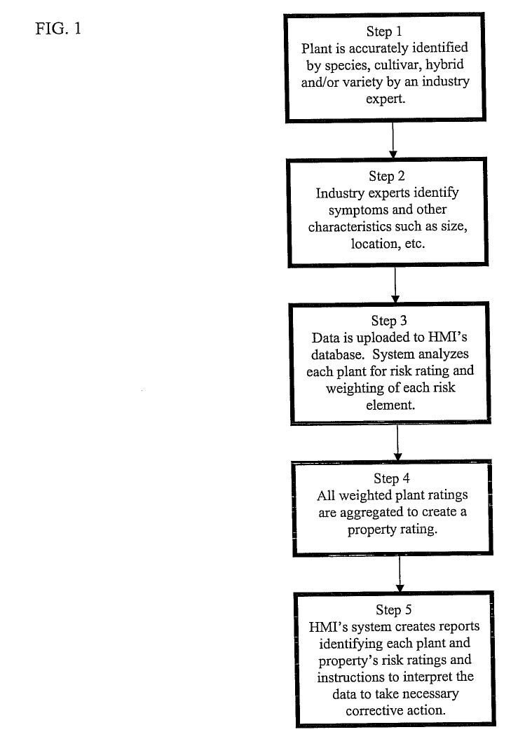

In some exemplary embodiments, and generally referring to FIGS. 1-3, a property risk rating system and method may be described. For example, the system and method can determine a risk factor for one or more plants, trees, shrubs or any other landscape feature (hereinafter “plants”) by identifying the plant, sizing the plants, collecting data regarding condition and characteristics of the plant, locating the plant on a property with respect to other property or fixtures, uploading the information to a database which can contain pre-defined risk ratings for specific plants, plant conditions, local conditions and proximity characteristics; applying to these ratings pre-defined weights with regard to the importance of each to the overall risk that a plant may fail (die, fall or lose limbs) and may create a risk to nearby property. Also, a risk rating for the property may be determined using any of a variety of additional data. Further, the system and method may include a variety of embodiments and may be useful to assess or test environments and items not specifically discussed herein.

One exemplary embodiment, as shown in FIG. 1, may involve a method and system for identifying plants that can include a variety of steps. Plants for which a risk rating may be established can be accurately identified by species and/or cultivar, hybrid or variety by an appropriate party, such as a trained professional. Each plant species and/or cultivar, hybrid or variety can have one or more unique genetic characteristics which make it important that a correct identification be made. Failure to properly identify a species may result in an incorrect risk profile.

After each plant is accurately identified, specific information about the size, condition, location on property or other characteristics of each plant may be collected. This information may again be collected by an appropriate party with experience in the identification of adverse symptoms, structural or mechanical problems and other features and/or conditions which may be used in the development of the risk rating.

Following on-site data collection, the information about each plant may be uploaded to a relational database which can be used to evaluate the risk rating of each plant and the group of plants on a single property. The database may be any database known in the art and may be coupled directly to a processor or a server, for example over a communications link.

The database may include established ratings for the performance of each species, cultivar, hybrid or variety against key genetic features. In some exemplary embodiments, genetic features such as structural integrity, root depth/spread, leaf retention, growth habit, drought tolerance, fire resistance, insect tolerance, disease tolerance, whether it is lightning prone and abiotic stress tolerance, amongst others can be rated. The ratings may compare each species, cultivar, hybrid or variety against all other species, cultivars, hybrids or varieties on each feature.

The database can then apply an established weighting factor against each rating assigned to the species, cultivar, hybrid or variety described above to determine the genetic risks of each plant. The weighting factors may represent the relative impact of each genetic feature with regard to the long-term viability of each plant.

Further, in some embodiments, the database can also include a rating of each assessed plant based on a plant's features and/or conditions. Unique features may include plant size and location relative to homes, structures or other personal property as well as physical/proximity attributes which may make the plant lightning prone. Conditions pertaining to the health and structural integrity of each plant may also be analyzed. The system can consider if conditions such as dieback, structural defect, mechanical injury, crown imbalance or others exist and the extent to which they exist, when determining a plant risk rating.

In some exemplary embodiments, database logic may be developed which can apply a rating for each feature and/or condition described above. For example a plant size rating may vary from 1-100 depending on the actual size of the plant (5″ to 10″ dbh-15, 10.25″ to 20″ dbh-25, 20.25″ to 40″ dbh-40, etc). As with the genetic attributes described above, the system may then apply an established weighting factor against each unique plant feature and/or condition based on the feature's and/or condition's impact on the overall risk of failure.

Following the establishment of a weighting factor, the system may aggregate all normalized (weighted) genetic, unique plant and environmental features and/or conditions to determine an overall risk rating for each plant. The system can represent not only a risk factor for plant failure, but it can also provide an assessment of those plants which are proximate to a home or other structure.

Additionally, following the calculation of an individual plant risk rating the database can compare each plant against a pre-determined optimum plant rating. A numerical result can then be produced comparing each assessed plant against this optimum rating. The database may also create specific risk rating metrics for environmental threats. For example, a plant's genetic ability to tolerate high winds or ice/snow can be determined by aggregating the individual results for structural integrity, root depth/spread, leaf retention and growth habit.

Also, for plant, property and environmental risks, the database can establish thresholds for low, moderate and high risks. These thresholds may be based upon established metrics developed with industry experts. Then, the database can create printed or electronic reports for a property owner, potential property owner, insurer or other interested party, a report identifying each plant and its risk rating as well as a complete property risk rating. Instructional information may be coupled with the rating that can explain on how to interpret the data and potentially suggest any of a variety of actions which could be taken to reduce elevated risks from specific plants.

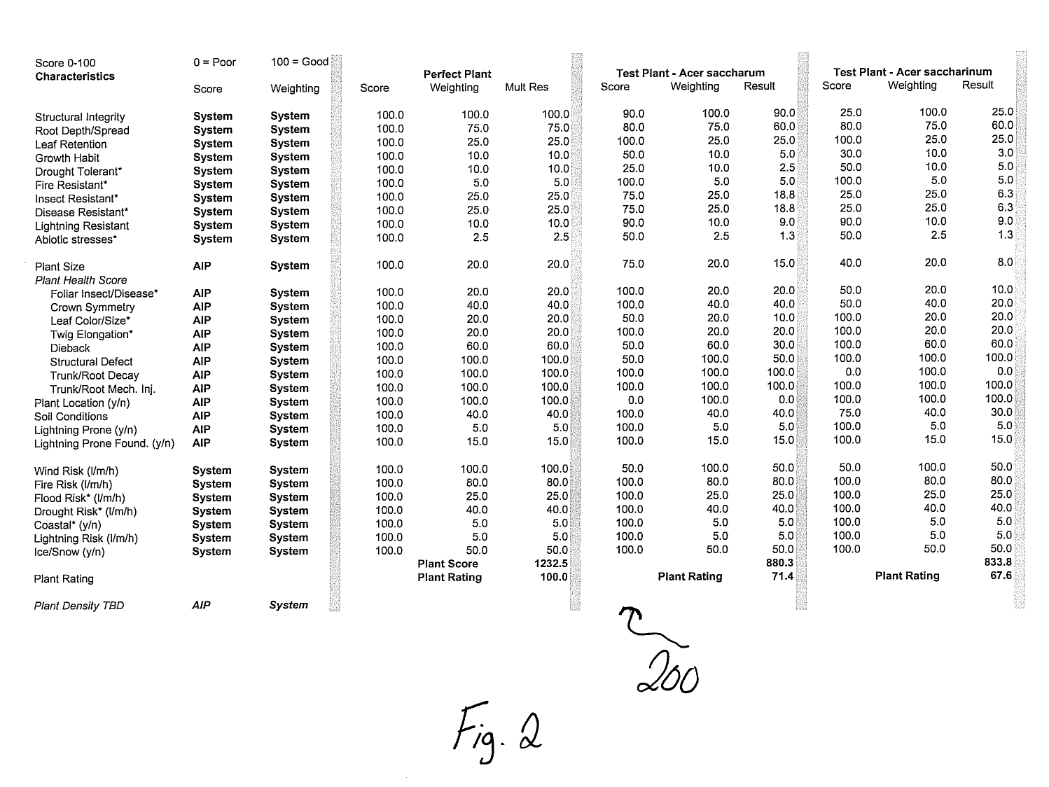

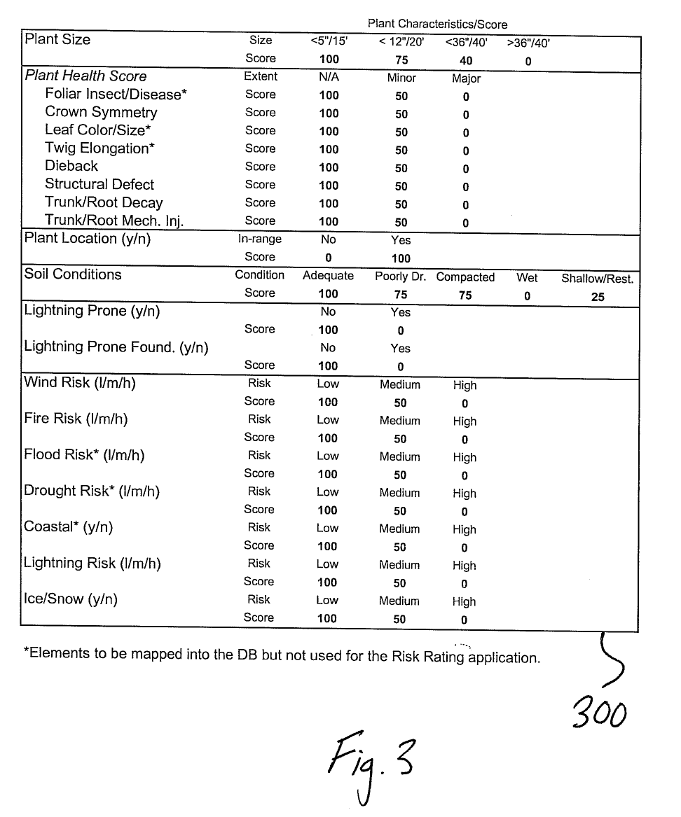

In another exemplary embodiment, and referring to the exemplary data in FIGS. 2-3, a further risk rating system and method are described. In this embodiment, additional data regarding plants may be used to generate risk assessments. For example, genetic characteristic data related to how a plant is able to withstand certain environmental conditions may be utilized. Further, data collected through an asset inventory program may also be used.

Additionally, exemplary FIGS. 2-3 may provide information regarding specific genetic and local conditions that may be used in a variety of exemplary embodiments. FIGS. 2-3 may also include numerical scores that can be assigned to individual genetic and local characteristics. In these exemplary figures, table 200 of FIG. 2 may show exemplary ratings values for a variety of exemplary plants. Then, in table 300 of FIG. 3, exemplary characteristics of the exemplary plants may be shown. Further, weights may also be applied to each characteristic, as described below.

In some exemplary embodiments, a database may include any number of plants and a rating may be assigned to each one. Ratings can be assigned regardless of the likelihood that the plant will damage or threaten any proximately located assets, property or fixtures.

As mentioned previously, a score may be generated and assigned for each genetic, plant and property characteristic. The score may be indicative of the presence and/or extent of a specific characteristic. For example, with regard to plant symptoms collected using an asset inventory program, a plant can receive a score of 100 for each symptom which is not present or affecting less than 5% of a plant. Similarly, the plant may receive a score of 50 and 0 for symptoms present and affecting 6-15% and 16+% of a section of the plant, respectively. These numbers should be considered as exemplary, however, and both the scores and ranges may vary in different embodiments. In a further example, the scoring system may be such that a higher score will be preferred with regard to any genetic, plant or property characteristic, with a score of 100 being the highest possible score and a score of 0 being the lowest possible score.

Additionally, weights may be provided to the genetic, plant and property characteristics. For example, each genetic, plant and property characteristic score may be weighted based upon the relative importance of each characteristic compared with all other characteristics. The weighting factor may act to normalize all characteristics and emphasize the most important factors which affect the plants' overall risk.

Any of a variety of unique genetic characteristics may be mapped as part of the risk assessment method and system. The genetic characteristics may be mapped to specific genus/species or, in some circumstances, genus/species/cultivar level records in the database. Exemplary characteristics include, but are not limited to: structural integrity, root depth and spread, leaf retention, growth habit, drought tolerance, fire resistance, insect resistance, disease resistance, lighting resistance and abiotic stress resistance. The database can include both a score and weight for any characteristic. Additionally, the system and method may use any single or combination of characteristics in generating a risk assessment.

In still further exemplary embodiments, various other characteristics may be collected and stored in the database for analysis. Such characteristics may be typically associated with, but not limited to, trees. However, unlike the characteristics described previously, these characteristics may not be mapped to each genus/species or genus/species/cultivar record in the database. Instead, these characteristics may be unique to an individual property that is inventoried or inspected. Examples of these characteristics include, but are not limited to: foliar insect/disease, crown symmetry, leaf color/size, twig elongation, dieback, structural defect, trunk/root decay, trunk/root mechanical injury, root restriction, tree location, soil conditions, lighting prone and lighting prone-foundation. Each of these characteristics may receive a score based on its condition, location relative to a structure and lighting risk. Similar to the other genetic conditions, each of these characteristics may be weighted with regard to the importance of each to the overall risk of the tree.

In a further exemplary embodiment, each of the tree characteristics may have a variable score from tree to tree on a property and from property to property. As again shown in FIGS. 2-3, an exemplary scoring mechanism may be shown. The score can be based on the data collected on each tree during the inventory or inspection process. For example tree can receive a score of 100, 50 and 0 for symptoms which exists at the 0-5%, 6-15% and 16%+ratings, respectively.

In still further exemplary embodiments, the method and system may incorporate characteristics that are property-specific. These conditions, which may be collected at any geographic level, such as zip code, may be characteristics related to the probability of certain natural conditions affecting a property or related assets. Such conditions include, but are not limited to, wind, flooding, droughts, ice/snow, lighting and saline (for coastal areas). Similar to the previous characteristics, each property score for these characteristics may vary, for example, from one property to another. Also, the data may be acquired from any source, such as a third party provider, and then incorporated into the database for assessment with any other characteristics. Also, the scoring for these characteristics may be such that a low value would receive a score of 100, a medium value would receive a score of 50 and a high value would receive a score of 0, although any other scoring methodology may be used.

In one example, an arithmetic formula may be used to combine a unique genetic characteristic score and weight to determine a sub-rating of each plant for each characteristic. The data of different plants may be compared in the database in this manner. For example, if Plant A has a characteristic 1 score of 100 and a characteristic 1 weight of 50, the result of Plant A will be 50. Plant B may have a characteristic 1 score of 50 and a characteristic 1 weight of 50, giving it a result of 25. Therefore, it may be reported that Plant A is superior to Plant B for this characteristic.

In another example, multiple characteristics may be combined to ascertain a specific risk profile. For example, three unique charactertics may indicate a plant's susceptibility to a particular risk factor (e.g. fire, flood, ice, etc.). Results for multiple characteristics may then be ascertained and shown as a final value. In one example, Plant A may have a characteristic 1 score of 50 and a characteristic 1 weight of 75, for a result of 37.5, a characteristic 2 score of 100 and characteristic 2 weight of 50, for a result of 50.0 and a characteristic 3 score of 75 and a characteristic 3 weight of 100, for a result of 75.0. If the three results are combined, a total value of 162.5 is shown. This final rating may then be compared to a known or ideal baseline rating to determine a relative risk of this plant compared with an exemplary ideal plant or any other plants on a property.

An exemplary manner of determining a known or ideal baseline rating is as follows. The baseline value may be one whereby a baseline plant would have scores of 100 for each characteristic. Thus, in the above example, the baseline result for characteristic 1 would be 75, the baseline result for characteristic 2 would be 50 and the baseline result for characteristic 3 would be 100, giving it a total value of 75+50+100=225. Using this value, a risk rating for a plant, such as Plant A in the above example may be made by comparing the combined result of Plant A with the baseline result. In this example, Plant A would have a risk rating of (162.5/225)=72.2. According to different embodiments, the risk rating system and method may be modifiable in any of a variety of manners so as to allow for a predetermined set of characteristics to be established for a risk rating.

In still another exemplary embodiment, an overall risk rating for a property may be determined. Here, incremental risk from property to property based upon a variety of factors, such as type, density, health and location of the property, may be performed and a risk rating determined.

Additionally, in a further exemplary embodiment, any of a variety of manners of reporting risk results may be utilized. For example, results may be provided to various parties in the form of reports. The reports may contain any of the risk ratings described above in any of a variety of formats, and may include individual or group ratings. Additionally, any report may be supplemented with a listing of plants that may be considered at an elevated risk level. This supplemental listing can contain information about plants located on a property, within a predetermined distance from structures or assets on a property and any other desired information.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed:

1. A method of assessing a risk factor to property, comprising:
identifying at least one plant;
sizing the at least one plant;
collecting data regarding location, condition and characteristics of the at least one plant;
uploading the data to a database;
comparing the data to predefined ratings associated with the at least one plant;
applying the predefined ratings to the at least one plant to determine if the plant will fail;
determining the likelihood of adverse environmental conditions that may affect the at least one plant; and
determining a risk factor of the at least one plant to a property proximate to the at least one plant.

2. The method of claim 1, wherein the predefined ratings are risk ratings.

3. The method of claim 1, wherein the predefined ratings include at least one of a risk rating for the at least one plant, a condition of the at least one plant, a condition of the area where the at least one plant is located and a proximity of the at least one plant to property.

4. The method of claim 1, further comprising weighting the predefined ratings associated with the plant.

5. The method of claim 1, wherein the at least one plant is a group of plants located on a piece of property.

6. The method of claim 1, further comprising combining the risk factor of the at least one plant to a property proximate the at least one plant with the risk factor of any other plants proximate the property.

7. The method of claim 1, further comprising weighting the predefined ratings to provide a numerical value for the risk assessment.

8. A system for assessing risk to property, comprising:
a processor;
a memory associated with the processor;
a piece of property having one or more plants located thereon;
data regarding one or more plants located on the piece of property;
data regarding the property; and
a database of predetermined characteristics of the one or more plants, wherein the data regarding the one or more plants and the data regarding the property is inputted into the memory and compared to the predetermined characteristics of the one or more plants in the database to provide a risk assessment for the piece of property.

9. The system of claim 8, wherein the database is a relational database.

10. The system of claim 8, wherein the data regarding the one or more plants is at least one of a size of the at least one plant, a location of the at least one plant, health of the at least one plant and a condition of the at least one plant.

11. The system of claim 8, wherein the predetermined characteristics of the one or more plants are genetic characteristics.

12. The system of claim 11, wherein the genetic characteristics are at least one of structural integrity, root depth, root spread, leaf retention, growth habit, drought tolerance, fire resistance, insect tolerance, disease tolerance, abiotic stress tolerance and likelihood of lightning strikes.

13. The system of claim 8, wherein the data regarding the property is at least one of climate data, location data, environmental data and data regarding structures on the property.

14. The system of claim 8, wherein the data regarding the one or more plants, the data regarding the property and the predetermined characteristics are given weighted values.

15. The system of claim 14, wherein the processor compares the data regarding the one or more plants, the data regarding the property and the predetermined characteristics to provide an output, applies the weighted values to the compared data and outputs a risk assessment value using an arithmetic formula.

16. The system of claim 8, wherein the processor compares the data regarding more than one plant on the property to the data regarding the property and the predetermined characteristics and combines the data regarding more than one plant to provide a risk assessment for the property.

17. The system of claim 8, wherein the risk assessment is a numerical value.

18. The system of claim 8, wherein the database is remotely accessible.

19. The system of claim 8, wherein the risk assessment is an evaluation of whether the one or plants on the property will fail and cause damage to the property.

20. A risk assessment method, comprising:
means for identifying species of plants on a piece of property;
means for collecting data regarding the species of plants on the piece of property;
means for comparing the data regarding the species of plants on the piece of property to predetermined characteristics of the species of plants on the piece of property; and
means for outputting a risk assessment for the piece of property.
